(19) United States
(12) Patent Application Publication
(10) Pub. No.: US 2015/0160475 A1
(43) Pub. Date: Jun. 11, 2015

(54) Liquid Crystal Based Contact Lens

(71) Applicants: BOE Technology Group Co., Ltd., Beijing (CN); Beijing BOE Optoelectronics Technology Co., Ltd., Beijing (CN)

(72) Inventors: Jiuxia Yang, Beijing (CN); Jiantao Liu, Beijing (CN); Feng Bai, Beijing (CN)

(73) Assignees: BOE Technology Group Co., Ltd., Beijing (CN); Beijing BOE Optoelectronics Technology Co., Ltd., Beijing (CN)

(21) Appl. No.: 14/355,357

(22) PCT Filed: Dec. 3, 2013
(86) PCT No.: PCT/CN2013/088436

§ 371 Date: Apr. 30, 2014

(30) Foreign Application Priority Data
Aug. 20, 2013 (CN) 201310363351.4

(51) Int. Cl. G02C 7/04

(52) U.S. Cl. CPC G02C 7/049; G02C 2202/18

(57) ABSTRACT

A liquid crystal based contact lens comprises a first substrate and a second substrate which are aligned-and-assembled, and a liquid crystal layer disposed between the first substrate and the second substrate, the first substrate comprises a first transparent flexible substrate base, and a first alignment film comprising first alignment grooves, the first alignment film is provided on the first transparent flexible substrate base, the first alignment grooves extend to the edge of the liquid crystal based contact lens in annular shapes with their geometric centers located at the center of the lens, the second substrate comprises a second transparent flexible substrate base, and a second alignment film comprising second alignment grooves, the second alignment grooves corresponds to the first alignment grooves, the second alignment film is provided on the second transparent flexible substrate base, the liquid crystal layer is disposed between the first alignment film and the second alignment film.

### FIELD OF THE INVENTION

The present invention relates to liquid crystal display technology, and in particular, to a liquid crystal based contact lens.

### BACKGROUND OF THE INVENTION

A contact lens, which is also called corneal contact lens, is a lens for correcting vision or protecting eyes by being worn on the cornea of the eyeball. Currently, the materials for the contact lens are generally silicon-based hydrogel and hydrated polymer (such as methyl methacrylate, hydroxyethyl methacrylate, glycerin methacrylate etc.). The contact lens can be classified into three types of rigid, semirigid, and soft. The contact lens can provide improvements in appearance and convenience to patients suffering from ametropia such as myopia or presbyopia, and can widen the view field and provide visual fidelity.

### SUMMARY OF THE INVENTION

The embodiments of the invention provide a liquid crystal based contact lens, which can adjust vision, improve ametropia, and provide convenience and beauty.

In order to achieve the above object, following solutions are adopted in the embodiments of the invention.

In one aspect, there is provided a liquid crystal based contact lens, which comprises a first substrate and a second substrate which are aligned-and-assembled, and a liquid crystal layer disposed between the first substrate and the second substrate, wherein the first substrate comprises a first transparent flexible substrate base, and a first alignment film comprising a plurality of first alignment grooves, the first alignment film is provided on the first transparent flexible substrate base, the first alignment grooves extend to the edge of the liquid crystal based contact lens in annular shapes with their geometric center located at the geometric center of the liquid crystal based contact lens, the second substrate comprises a second transparent flexible substrate base, and a second alignment film comprising a plurality of second alignment grooves, the second alignment grooves correspond to the first alignment grooves, and the second alignment film is provided on the second transparent flexible substrate base, and the liquid crystal layer is disposed between the first alignment film and the second alignment film.

Preferably, the depths of the first alignment grooves and the second alignment grooves sequentially increase from the geometric center to the edge of the liquid crystal based contact lens.

Preferably, the depths of the first alignment grooves and the second alignment grooves sequentially decrease from the geometric center to the edge of the liquid crystal based contact lens.

Preferably, the annular shape is a circle shape or an oval shape.

Further preferably, the liquid crystal based contact lens further comprises a plurality of transistors provided on the first transparent flexible substrate base, a plurality of first electrodes each of which is electrically connected to one of the electrodes of the corresponding transistors, and a plurality of second electrodes provided on the first transparent flexible substrate base or the second transparent flexible substrate base.

Further preferably, the plurality of transistors comprise thin film transistors.

Preferably, the liquid crystal based contact lens further comprises a driving module for driving the liquid crystal molecules in the liquid crystal layer of the liquid crystal based contact lens to deflect.

Further preferably, the liquid crystal based contact lens further comprises an optical sensor and a control module, wherein the optical sensor is used for receiving a control signal and transmitting the control signal to the control module; and the control module controls the driving module according to the control signal so as to drive the liquid crystal molecules in the liquid crystal layer to deflect.

Preferably, the liquid crystal based contact lens further comprises a thin film cell unit provided on a surface of the first transparent flexible substrate base or the second transparent flexible substrate base far away from the liquid crystal layer.

Further preferably, the thin film cell unit includes a solar cell.

Further preferably, the solar cell includes a P-type silicon pattern layer, an N-type silicon pattern layer, and an intrinsic silicon pattern layer disposed between the P-type silicon pattern layer and the N-type silicon pattern layer.

The embodiments of the invention provide a liquid crystal based contact lens, which comprises a first substrate and a second substrate which are aligned-and-assembled, and a liquid crystal layer disposed between the first substrate and the second substrate, wherein the first substrate includes a first transparent flexible substrate base, and a first alignment film including a plurality of first alignment grooves provided on the first transparent flexible substrate base, the first alignment grooves extend to the edge of the liquid crystal based contact lens in annular shapes with their geometric centers located at the geometric center of the liquid crystal based contact lens; the second substrate comprises a second transparent flexible substrate base, and a second alignment film comprising a plurality of second alignment grooves provided on the second transparent flexible substrate base, the second alignment grooves corresponding to the first alignment grooves, and the liquid crystal layer is disposed between the first alignment film and the second alignment film. The liquid crystal molecules in the liquid crystal layer are arranged in the alignment grooves in a certain law so that the liquid crystal based contact lens may obtain a desired refractive index and the user's demand on diopter may be satisfied, and thus the adjustment of the vision, improvement in ametropia and convenience and beauty may be achieved.

### BRIEF DESCRIPTION OF THE DRAWINGS

To more clearly describe the embodiments of the present invention and the technical solutions in the prior art, the drawings that are used in describing the embodiments and the prior art will be briefed hereinafter. Obviously, the drawings described hereinafter are only embodiments of the present invention, and one skilled in the art can obtain other drawings from such drawings without ingenuity work.

FIG. 1 is a structure diagram of a liquid crystal based contact lens according to an embodiment of the invention.

FIG. 2 is a diagram showing one example of shapes of alignment grooves applied to the alignment film of the liquid crystal based contact lens according to the embodiment of the invention.

FIG. 3 is a diagram showing another example of shapes of alignment grooves applied to the alignment film of the liquid crystal based contact lens according to the embodiment of the invention.

FIG. 4 is a structure diagram of a liquid crystal based contact lens including a driving module according to an embodiment of the invention.

FIG. 5 is a structure diagram of a liquid crystal based contact lens including an optical sensor element and a control module according to an embodiment of the invention.

FIG. 6 is a structure diagram of a liquid crystal based contact lens including a thin film cell unit according to an embodiment of the invention.

FIG. 7 is a diagram showing the adjusting process of the liquid crystal based contact lens according to an embodiment of the invention.

### DESCRIPTION OF REFERENCE NUMBER

10—liquid crystal based contact lens; 101—first substrate; 1011—first transparent flexible substrate base; 1012—first alignment groove; 1013—first alignment film: 102-second substrate; 1021—second transparent flexible substrate base; 1022—second alignment groove; 1023—second alignment film: 103—liquid crystal layer: 20—driving module; 30—optical sensor element; 40—control module; 50—thin film cell unit

### DETAILED DESCRIPTION OF THE INVENTION

The technical solutions in the embodiments of the present invention will be described clearly and thoroughly hereinafter in combination with the drawings of the embodiments of the present invention. Obviously, the embodiments described herein are only a part, rather than all, of the embodiments of the present invention. All the other embodiments obtained by skilled persons in the art in light of the embodiments of the present invention fall within the protection scope of the present invention.

As shown in FIG. 1, a liquid crystal based contact lens 10 in an embodiment of the invention comprises a first substrate 101 and a second substrate 102 which are aligned-and-assembled, and a liquid crystal layer 103 disposed between the first substrate and the second substrate. The first substrate 101 comprises a first transparent flexible substrate base 1011, and a first alignment film 1013 including a plurality of first alignment grooves 1012 provided on the first transparent flexible substrate base 1011, and the first alignment grooves 1012 extend to the edge of the liquid crystal based contact lens 10 in annular shapes with their geometric centers located at the geometric center of the liquid crystal based contact lens 10. The second substrate 102 comprises a second transparent flexible substrate base 1021, and a second alignment film 1023 comprising a plurality of second alignment grooves 1022 provided on the second transparent flexible substrate base, and the second alignment grooves 1022 correspond to the first alignment grooves 1012.

The first alignment grooves 1012 and the second alignment grooves 1022, on one hand, can fix the liquid crystal molecules in the grooves and adjust the arrangement of the liquid crystal molecules, and on the other hand, can divide the liquid crystal molecules in the liquid crystal layer 103 into a plurality of annular regions, geometric centers of which are located at the geometric center of the liquid crystal based contact lens 10, and the annular regions have different radius. When the liquid crystal based contact lens 10 is used as a contact lens for myopia, as the lens is a concave lens whose refractive index increases from its geometric center to its edge. Therefore, the first alignment grooves 1012 and the second alignment grooves 1022 may divide the space between them into a plurality of annular regions, geometric centers of which are located at the geometric center of the liquid crystal based contact lens 10, and the annular regions have different radius. Then liquid crystal molecules with different refractive indexes are injected into these regions, so that the refractive indexes of liquid crystal molecules in these annular regions increase sequentially from the geometric center of the lens to the edge thereof.

When the liquid crystal based contact lens 10 is used as a contact lens for hypermetropia, as the lens is a convex lens whose refractive index decreases from its geometric center to its edge. Therefore, the first alignment grooves 1012 and the second alignment grooves 1022 may divide the space between them into a plurality of annular regions, geometric centers of which are at the geometric center of the liquid crystal based contact lens 10, and the annular regions have different radius. Then liquid crystal molecules with different refractive indexes are injected into these regions, so that the refractive indexes of liquid crystal molecules in these annular regions decrease sequentially from the geometric center of the lens to the edge thereof.

Of course, liquid crystals in different annular regions may have the same refractive index through, for example, injecting the liquid crystals with the same refractive indexes thereinto so that the liquid crystal based contact lens 10 is used as a plane lens.

The following should be noted. First, the shapes of the alignment grooves of the liquid crystal based contact lens 10 may be any one of circle, oval, rectangle and trapezoid, so long as they can be closed, so they are not limited herein.

Second, the second alignment grooves 1022 corresponds to the first alignment grooves 1012, which means that their projections are overlapped, and if the first alignment grooves 1012 have the same depth, then the second alignment grooves 1022 also have the same depth; and if the first alignment grooves 1012 have different depths, then the second alignment grooves 1022 also have different depths. That is, the first alignment grooves 1012 and the second alignment grooves 1022 have the same depths at corresponding positions.

In the embodiment of the invention, the depths of the first alignment grooves 1012 and the second alignment grooves 1022 are designed depending on the refractive indexes of the liquid crystal molecules in the liquid crystal layer 103, so that the liquid crystal molecules, the depths of the alignment grooves and the liquid crystal layer 103 may match each other best, thereby the demand on the refractive index of concave lens and convex lens may be met.

Third, the first transparent flexible substrate base 1011 and the second transparent flexible substrate base 1021 may be made of polymer materials, such as hydrophilic siloxane methacrylate, fluorosilicone acrylate, polyurethane hydrogel, and silk fibroin.

An embodiment of the invention provides a liquid crystal based contact lens 10 comprising a first substrate 101 and a second substrate 102 which are aligned-and-assembled, and a liquid crystal layer 103 disposed between the first substrate and the second substrate. The first substrate 101 comprises a first transparent flexible substrate base 1011, and a first alignment film 1013 including a plurality of first alignment grooves 1012 provided on the first transparent flexible substrate base 1011, and the first alignment grooves 1012 extend to the edge of the liquid crystal based contact lens 10 in annular shapes with their geometric centers located at the geometric center of the liquid crystal based contact lens 10. The second substrate 102 comprises a second transparent flexible substrate base 1021, and a second alignment film 1023 comprising a plurality of second alignment grooves 1022 provided on the second transparent flexible substrate base 1021, and the second alignment grooves 1022 corresponds to the first alignment grooves 1012.

As such, by arranging the liquid crystal molecules in the liquid crystal layer 103 into the alignment grooves according to certain laws so that the liquid crystal based contact lens has a desired refractive index and the user's demand on the diopter is met, thus achieving adjustment of the vision and improvement in ametropia while bringing about convenient and beautiful effects.

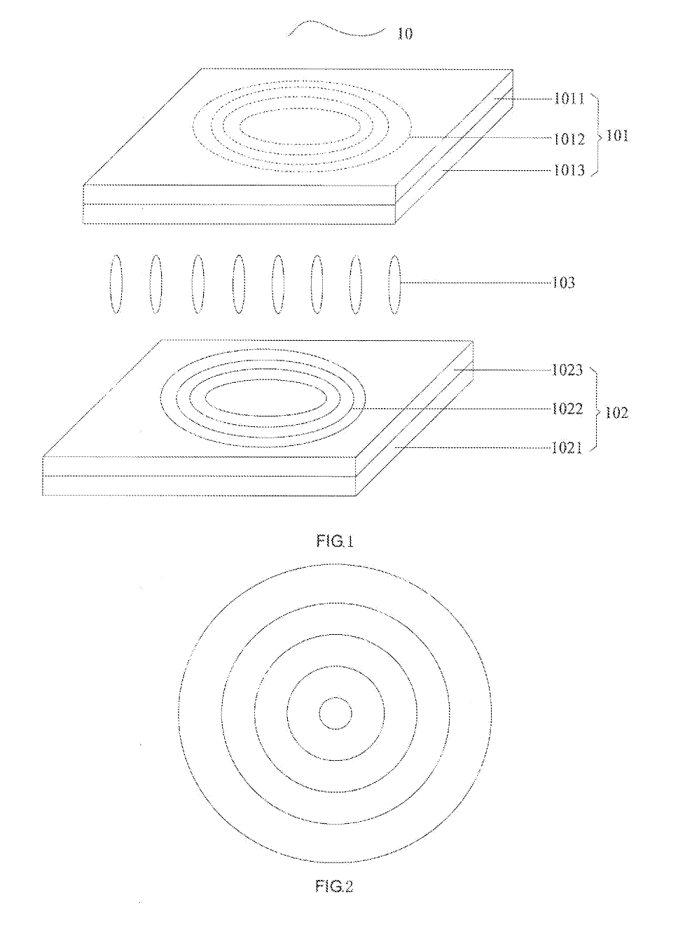

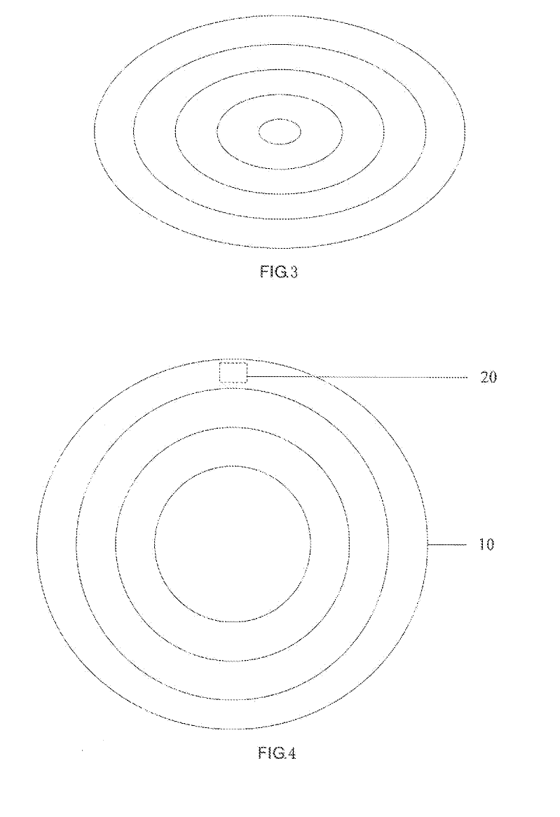

The shapes of the alignment grooves may be arbitrary closed shapes. However, when the shapes of the alignment grooves are rectangles or trapezoids, the alignment grooves will have sharp angles, which will affect the operation of the liquid crystal molecules in the liquid crystal layer 103, thus in turn causing poor display quality. Accordingly, as shown in FIGS. 2 and 3, the shapes of the alignment grooves are preferably circles or ovals in the embodiment of the invention.

Preferably, the depths of the first alignment grooves 1012 and the second alignment grooves 1022 may be increased sequentially from the geometric center to the edge of the liquid crystal based contact lens, or decreased sequentially from the geometric center to the edge of the liquid crystal based contact lens.

Whether the liquid crystal based contact lens 10 is a concave lens or a convex lens depends on combination of the liquid crystals, the depths of the alignment grooves and the thickness of the liquid crystal layer. With the adjustment of the arrangement of the liquid crystal molecules inside the alignment grooves so that demands on different refractive indexes are met, the focus length may be adjusted, thereby the user's demand on various myopic degrees or hypermetropia degrees may be met.

Here, the manufacture process of the alignment grooves may be optical alignment process, so long as the alignment grooves may be manufactured to have desired shapes and depths. However, as the liquid crystal based contact lens 10 belongs to glasses industry, therefore, in considering of process accuracy and process cost, the optical alignment process is preferably used as the process for manufacturing the alignment grooves in the invention.

The liquid crystal based contact lens 10 further comprises a plurality of transistors provided on the first transparent flexible substrate base 1011, a plurality of first electrodes each of which is electrically connected to one electrode of each of the transistors, and a plurality of second electrodes provided on the first transparent flexible substrate base 1011 or the second transparent flexible substrate base 1021. The one electrode of each of the transistors may be a source or a drain according to the types of the transistors.

Here, the second electrode may be provided on the second transparent flexible substrate base 1021, thus a vertical electric field may be formed between the first electrodes and the second electrodes to control the deflection of the liquid crystal molecules in the liquid crystal layer 103. Alternatively, the second electrodes may be provided on the first transparent flexible substrate base 1011, thus a transverse electric field may be formed between the first electrodes and the second electrodes to control the deflection of the liquid crystal molecules in the liquid crystal layer 103.

The transistors and the first electrodes provided on the first transparent flexible substrate base 1011 may be formed by a manufacture process similar to that for manufacturing the transistors and pixel electrodes in the current array substrate. The transistors may be thin film transistors so that the market demand on thinning may be met. The first substrate 101 may further comprise data lines connected to sources of the transistors, and through the data lines the first electrode may be charged to achieve the deflection of the liquid crystal molecules together with the contributions of the second electrode.

When the liquid crystal based contact lens 10 is used as a contact lens for myopia, the voltages between the first electrodes and the second electrodes may be adjusted so that the liquid crystal molecules in various annular regions may deflect at respective angles, thus the refractive indexes of the liquid crystal molecules are controlled to be increased sequentially from the geometric center of the lens to the edge thereof. Further, a fine adjustment of the focal length of the concave lens may be conducted depending on the user's demand on the myopia degree.

When the liquid crystal based contact lens 10 is used as a contact lens for hypermetropia, the voltages between the first electrodes and the second electrodes may be adjusted so that the liquid crystal molecules in various annular regions may deflect at respective angles, thus the refractive indexes of the liquid crystal molecules are controlled to be decreased sequentially from the geometric center of the lens to the edge thereof. Further, a fine adjustment of the focal length of a convex lens may be conducted depending on the user's demand on the hypermetropia degree.

Further, in the case of the liquid crystal based contact lens 10 comprising a plurality of transistors provided on the first transparent flexible substrate base 1011, a plurality of first electrodes each of which is electrically connected to one electrode of each of the transistors, and a plurality of second electrodes provided on the first transparent flexible substrate base 1011 or the second transparent flexible substrate base 1021, the liquid crystals in the liquid crystal layer 103 may be the same liquid crystals with the same refractive index, or may be the different liquid crystals with different refractive indexes.

In the case of the liquid crystals in the liquid crystal layer 103 being different liquid crystals with different refractive indexes, the different liquid crystals with different refractive indexes may be arranged according to certain laws depending on the use of the liquid crystal based contact lens 10.

For example, when the liquid crystal based contact lens 10 is used as a contact lens for myopia, in the ascending order of the refractive indexes, the liquid crystals with different refractive indexes are successively filled into the annular regions from inside to outside, when the liquid crystal based contact lens 10 is used as a contact lens for hypermetropia, in the descending order of the refractive indexes, the liquid crystals with different refractive indexes are successively filled into the annular regions from inside to outside.

Moreover, the depths of the alignment grooves in the different annular regions may be the same, or may be different. In the case that the same liquid crystals are injected into the liquid crystal layer 103 of the liquid crystal based contact lens 10 and the voltages between the first electrodes and the second electrodes are the same, when the depths of the alignments grooves are different, the liquid crystal layer 103 has different thicknesses, thus resulting in different focal lengths.

Accordingly, when the alignment grooves have different depths, the depths may be set according to the refractive indexes of the liquid crystals in the liquid crystal layer 103 so that the liquid crystals, the depths of the alignment grooves, the thickness of the liquid crystal layer 103, and the voltages between the first electrodes and the second electrodes may match each other best, thereby the fine adjustment of the focal length may be achieved.

For example, in the case of the depths of the alignment grooves being increased sequentially from the geometric center to the edge of the contact lens, the same kind of liquid crystals or different kinds of liquid crystals may be injected thereinside. The refractive indexes of the liquid crystals in various annular regions may be increased sequentially from the geometric center to the edge of the liquid crystal based contact lens 10 through controlling the voltages between the first electrodes and the second electrodes, so that the liquid crystal based contact lens 10 functions as a concave lens. As such, the refractive indexes of the liquid crystals in various annular regions may be decreased sequentially from the geometric center to the edge in the liquid crystal based contact lens 10 through controlling the voltages between the first electrodes and the second electrodes, so that the liquid crystal based contact lens 10 functions as a convex lens.

In the case of the depths of the alignment grooves being decreased sequentially from the geometric center to the edge of the contact lens, the same kind of liquid crystals or different kinds of liquid crystals may be injected thereinside. The refractive indexes of the liquid crystals in various annular regions may be decreased sequentially from the geometric center to the edge in the liquid crystal based contact lens 10 through controlling the voltages between the first electrodes and the second electrodes, so that the liquid crystal based contact lens 10 functions as a convex lens. As such, the refractive indexes of the liquid crystals in various annular regions may be increased sequentially from the geometric center to the edge in the liquid crystal based contact lens 10 through controlling the voltages between the first electrodes and the second electrodes, so that the liquid crystal based contact lens 10 functions as a concave lens.

Various refractive indexes may be realized in the alignment grooves by adjusting the arrangement of the liquid crystal molecules therein, so that the adjustment of the focal length may be achieved, thereby the user's demand on various myopia degrees or hypermetropia degrees can be satisfied.

A liquid crystal based contact lens 10 is provided in the embodiment of the invention, wherein the refractive indexes of the liquid crystals in the liquid crystal layer 103 may be adjusted according to the user's demands, so that the liquid crystal based contact lens 10 may function as a concave lens, a convex lens or a plane lens. In other words, when the refractive indexes of the liquid crystals of the liquid crystal layer 103 in various annular regions divided by the alignment grooves are adjusted to be increased sequentially from inside to outside, the liquid crystal based contact lens 10 may be made to function as a myopia lens; when the refractive indexes of the liquid crystals of the liquid crystal layer 103 in various annular regions divided by the alignment grooves are adjusted to be decreased sequentially from inside to outside, the liquid crystal based contact lens 10 may be made to function as a hypermetropia lens; and when the refractive indexes of the liquid crystals of the liquid crystal layer 103 in various annular regions divided by the alignment grooves are the same from inside to outside, the liquid crystal based contact lens 10 may be made to function as a plane lens. Moreover, when the liquid crystal based contact lens 10 functions as a myopia lens or a hypermetropia lens, fine adjustment of the focal length may be performed through adjusting the refractive indexes of the liquid crystals in the alignment grooves, so that different user's demands on the degree of the lens may be satisfied.

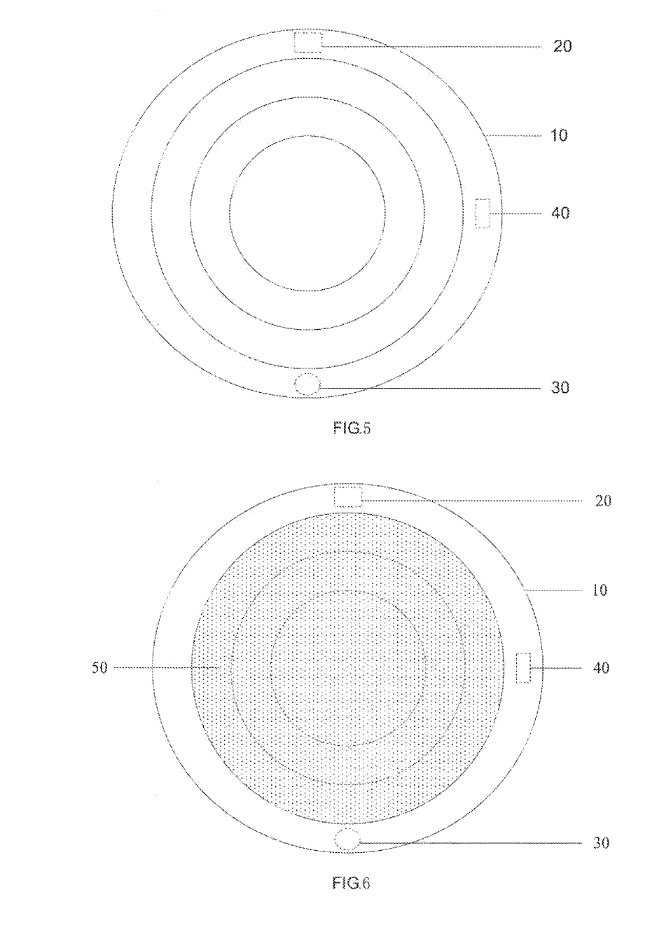

Further preferably, as shown in FIG. 4, the liquid crystal based contact lens 10 further comprises a driving module for driving the liquid crystal molecules in the liquid crystal layer 103 of the liquid crystal based contact lens 10 to deflect.

In the embodiment of the invention, the alignment grooves of the liquid crystal based contact lens 10 have geometric centers located at the geometric center of the liquid crystal based contact lens 10 and extend towards to the edge in annular shapes, and thus the liquid crystal based contact lens 10 is divided into a plurality of annular regions. The driving module 20 may apply a driving voltage to the different annular regions of the liquid crystal based contact lens 10 as desired, to drive the liquid crystal molecules in each of the annular regions to deflect at a certain angle, so as to control the refractive indexes of the liquid crystals in the annular regions to be, for example, increased or decreased sequentially from the geometric center to the edge of the liquid crystal based contact lens 10, thereby the liquid crystal based contact lens 10 can function as a myopia lens or a hypermetropia lens.

It should be noted that the driving voltage applied to the different annular regions should be determined depending on refractive indexes of the liquid crystals in the different annular regions, the depths of the alignment grooves, and the thickness of the liquid crystal layer, so that these parameters may match each other best, and a fine adjustment of the focal length can be realized.

Further preferably, as shown in FIG. 5, the liquid crystal based contact lens 10 further comprises an optical sensor element 30 and a control module 40. The optical sensor element 30 is used to receive a control signal and transmit the control signal to the control module 40. The control module 40 is used to control the driving module 20 according to the control signal so as to drive the liquid crystal molecules in the liquid crystal layer to deflect.

Here, an optical remote controller may be provided, the control signal may be transmitted through operating the adjustment button on the optical remote controller, the control signal is received by the optical sensor element 30 and transmitted to the control module 40, so that the control module 40 controls the driving module 20 according to the control signal so as to drive the liquid crystal molecules in the liquid crystal layer to deflect. Here, the control signals corresponding to various adjustment buttons on the optical remote controller may be set in advance, so as to operate the optical sensor element 30.

As such, the user can perform the adjustment of the liquid crystal based contact lens 10 only by controlling corresponding adjustment buttons on the optical remote controller. For example, when the liquid crystal based contact lens 10 is used as a myopia lens, the focal lengths of the liquid crystal based contact lenses 10 for the right eye and the left eye may be adjusted, that is, correcting the myopia degree; or when the liquid crystal based contact lens 10 is used as a hypermetropia lens, the focal lengths of the liquid crystal based contact lenses 10 for the right eye and the left eye may be adjusted, that is, correcting the hypermetropia degree; or when the liquid crystal based contact lens 10 is used as a hypermetropia lens, the liquid crystal based contact lens 10 may become a myopia lens through adjusting the focal lengths of the liquid crystal based contact lenses 10 for the right eye and the left eye.

For example, the user first presses an adjustment button on the optical remote controller corresponding to a control signal that is “adjusting the liquid crystal based contact lens for the left eye”, then the optical remote controller transmits the control signal to the optical sensor element 30. The control signal is received by the optical sensor element 30 and transmitted to the control module 40, thus entering into a control mode of “adjusting the liquid crystal based contact lens for the left eye”. The user next presses an adjustment button on the optical remote controller corresponding to a control signal that is “increasing the focal length of the liquid crystal based contact lens”, the optical remote controller transmits the control signal to the optical sensor element 30, the control signal is received by the optical sensor element 30 and transmitted to the control module 40, thus the control module 40 controls the driving module 20 to drive the liquid crystal molecules in the liquid crystal layer of the liquid crystal based contact lens for the left eye to deflect according to the control signal, so as to perform the adjustment of the focal length.

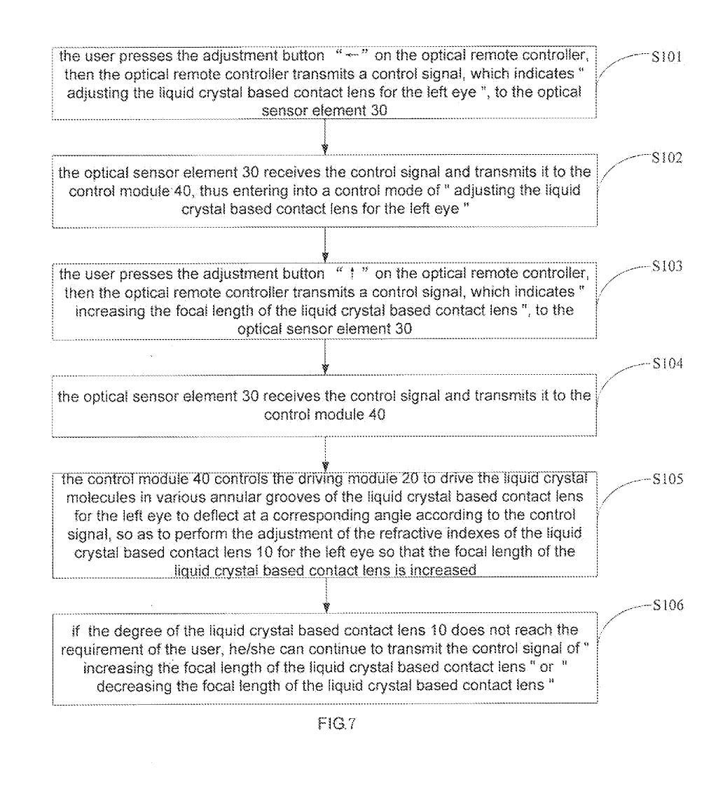

Preferably, as shown in FIG. 6, the liquid crystal based contact lens 10 further comprises a thin film cell unit 50 provided on a surface of the first transparent flexible substrate base or the second transparent flexible substrate base far away from the liquid crystal layer.

Here, specifically, if the first transparent flexible substrate base 1011 is located far away from the eye than the second transparent flexible substrate base 1021, the thin film cell unit 50 may provided on a surface of the first transparent flexible substrate base 1011 far away from the liquid crystal layer.

Further, the thin film cell unit 50 includes a solar cell.

The solar cell may include a P-type silicon pattern layer, an N-type silicon pattern layer, and an intrinsic silicon pattern layer disposed between the P-type silicon pattern layer and the N-type silicon pattern layer.

Further, the optical remote controller may have a switch for controlling the thin film cell unit 50 of the liquid crystal based contact lens 10 to supply power. As a result, the switch may be turned off when the liquid crystal based contact lens 10 is not worn, so that the liquid crystal based contact lens 10 stops operating, and the switch may be turned on when the liquid crystal based contact lens 10 is worn next time, so that the liquid crystal based contact lens 10 operates normally.

Above liquid crystal based contact lens 10 will be explained in detail using following embodiment.

The liquid crystal based contact lens 10 comprises a first substrate 101 and a second substrate 102 which are aligned-and-assembled, and a liquid crystal layer 103 disposed between the first substrate and the second substrate. The first substrate 101 comprises a first transparent flexible substrate base 1011, and a first alignment film 1013 including a plurality of first alignment grooves 1012 provided on the first transparent flexible substrate base 1011, and the first alignment grooves 1012 extend to the edge of the liquid crystal based contact lens 10 in annular shapes with their geometric centers located at the geometric center of the liquid crystal based contact lens 10. The second substrate 102 comprises a second transparent flexible substrate base 1021, and a second alignment film 1023 comprising a plurality of second alignment grooves 1022 provided on the second transparent flexible substrate base, and the second alignment grooves 1022 corresponds to the first alignment grooves 1012, wherein the depths of the alignment grooves are increased from the geometric center outwards, and liquid crystals in the liquid crystal layer 103 are one kind of liquid crystals with the same refractive index.

The liquid crystal based contact lens 10 further comprises a driving module 20, an optical sensor element 30 and a control module 40, wherein the optical sensor element 30 is used to receive a control signal and transmits the control signal to the control module 40, and the control module 40 is used to control the driving module 20 according to the control signal so as to drive the liquid crystal molecules in the liquid crystal layer to deflect.

Moreover, the liquid crystal based contact lens 10 further comprises a solar cell, the solar cell may include a P-type silicon pattern layer, an N-type silicon pattern layer, and an intrinsic silicon pattern layer disposed between the P-type silicon pattern layer and the N-type silicon pattern layer.

When the myopia user wears the liquid crystal based contact lens 10 and the focal length of the liquid crystal based contact lens 10 for the left eye will be adjusted, as shown in FIG. 7, following steps are performed:

S101, the user presses the adjustment button “←” on the optical remote controller, then the optical remote controller transmits a control signal, which indicates “adjusting the liquid crystal based contact lens for the left eye”, to the optical sensor element 30.

S102, the optical sensor element 30 receives the control signal and transmits it to the control module 40, thus entering into a control mode of “adjusting the liquid crystal based contact lens for the left eye”.

S103, the user presses the adjustment button “†” on the optical remote controller, then the optical remote controller transmits a control signal, which indicates “increasing the focal length of the liquid crystal based contact lens”, to the optical sensor element 30.

S104, the optical sensor element 30 receives the control signal and transmits it to the control module 40.

S105, the control module 40 controls the driving module 20 to drive the liquid crystal molecules in various annular grooves of the liquid crystal based contact lens for the left eye to deflect at a corresponding angle according to the control signal, so as to perform the adjustment of the refractive indexes of the liquid crystal based contact lens 10 for the left eye so that the focal length of the liquid crystal based contact lens is increased.

S106, if the degree of the liquid crystal based contact lens 10 does not reach the requirement of the user, he/she can continue to transmit the control signal of “increasing the focal length of the liquid crystal based contact lens” or “decreasing the focal length of the liquid crystal based contact lens”.

Described above are just specific embodiments of the present invention, while the scope of protection of the present invention is not limited to this, any person skilled in this field can easily conceive changes and substitutions within the technical scope disclosed by the present invention, which shall be covered in the scope of protection of the present invention, thus, the scope of protection of the present invention shall be defined by the scope of protection of the claims.

1. A liquid crystal based contact lens, comprising a first substrate and a second substrate which are aligned-and-assembled, and a liquid crystal layer disposed between the first substrate and the second substrate, wherein
the first substrate comprises a first transparent flexible substrate base, and a first alignment film comprising a plurality of first alignment grooves, the first alignment film is provided on the first transparent flexible substrate base,
the first alignment grooves extend to the edge of the liquid crystal based contact lens in annular shapes with a geometric center located at the geometric center of the liquid crystal based contact lens,
the second substrate comprises a second transparent flexible substrate base, and a second alignment film comprising a plurality of second alignment grooves, the second alignment grooves correspond to the first alignment grooves, and the second alignment film is provided on the second transparent flexible substrate base, and
the liquid crystal layer is disposed between the first alignment film and the second alignment film.

2. The liquid crystal based contact lens according to claim 1, wherein the depths of the first alignment grooves and the second alignment grooves sequentially increase from the geometric center to the edge of the liquid crystal based contact lens.

3. The liquid crystal based contact lens according to claim 1, wherein the depths of the first alignment grooves and the second alignment grooves sequentially decrease from the geometric center to the edge of the liquid crystal based contact lens.

4. The liquid crystal based contact lens according to claim 1, wherein the annular shape is a circle shape or an oval shape.

5. The liquid crystal based contact lens according to claim 1, further comprising a plurality of transistors provided on the first transparent flexible substrate base, a plurality of first electrodes each of which is electrically connected to one of the electrodes of the corresponding transistors, and a plurality of second electrodes provided on the first transparent flexible substrate base or the second transparent flexible substrate base.

6. The liquid crystal based contact lens according to claim 5, wherein the plurality of transistors comprise thin film transistors.

7. The liquid crystal based contact lens according to claim 5, further comprising a driving module for driving the liquid crystal molecules in the liquid crystal layer of the liquid crystal based contact lens to deflect.

8. The liquid crystal based contact lens according to claim 7, further comprising an optical sensor and a control module, wherein
the optical sensor is used for receiving a control signal and transmitting the control signal to the control module; and
the control module controls the driving module according to the control signal so as to drive the liquid crystal molecules in the liquid crystal layer to deflect.

9. The liquid crystal based contact lens according to claim 5, further comprising a thin film cell unit provided on a surface of the first transparent flexible substrate base or the second transparent flexible substrate base far away from the liquid crystal layer.

10. The liquid crystal based contact lens according to claim 9, wherein the thin film cell unit includes a solar cell.

11. The liquid crystal based contact lens according to claim 10, wherein the solar cell includes a P-type silicon pattern layer, an N-type silicon pattern layer, and an intrinsic silicon pattern layer disposed between the P-type silicon pattern layer and the N-type silicon pattern layer.

12. The liquid crystal based contact lens according to claim 2, further comprising a plurality of transistors provided on the first transparent flexible substrate base, a plurality of first electrodes each of which is electrically connected to one of the electrodes of the corresponding transistors, and a plurality of second electrodes provided on the first transparent flexible substrate base or the second transparent flexible substrate base.

13. The liquid crystal based contact lens according to claim 3, further comprising a plurality of transistors provided on the first transparent flexible substrate base, a plurality of first electrodes each of which is electrically connected to one of the electrodes of the corresponding transistors, and a plurality of second electrodes provided on the first transparent flexible substrate base or the second transparent flexible substrate base.

14. The liquid crystal based contact lens according to claim 4, further comprising a plurality of transistors provided on the first transparent flexible substrate base, a plurality of first electrodes each of which is electrically connected to one of the electrodes of the corresponding transistors, and a plurality of second electrodes provided on the first transparent flexible substrate base or the second transparent flexible substrate base.
